(19) United States
(12) Patent Application Publication
(10) Pub. No.: US 2006/0293496 A1
(43) Pub. Date: Dec. 28, 2006

(54) Process for preparing basic polycondensation products

(76) Inventor: Wolfgang Brennich, Reutlingen (DE)

Correspondence Address: HARNESS, DICKEY & PIERCE, P.L.C., P.O. BOX 828, BLOOMFIELD HILLS, MI, 48303, US

(21) Appl. No.: 10/502,254

(22) PCT Filed: Jan. 21, 2003
(86) PCT No.: PCT/EP03/00524

§ 371 Date: Apr. 15, 2005

(30) Foreign Application Priority Data
Jan. 25, 2002 (DE) 102 02 767.6

(51) Int. Cl. C08G 69/08

(52) U.S. Cl. 528/310

(57) ABSTRACT

The present invention relates to the preparation of basic polycondensation products obtainable by the reaction of polyfunctional amines with aqueous acids, distilling off the water and subsequent anhydrous polycondensation with cyano compounds.

The present invention relates to the preparation of basic polycondensation products obtainable by the reaction of polyfunctional amines with aqueous acids, distilling off the water and subsequent anhydrous polycondensation with cyano compounds.

Processes for preparing comparable polycondensation products as known from the prior art are based on the reaction of polyfunctional amines with ammonium salts and subsequent polycondensation with cyano compounds. Such processes could be optimized by the addition of solvents, as described, for example, in EP 0 431 423 B1 and EP 0 692 511 B1. In EP 0 938 515 B1, a process is described in which polyfunctional amines are reacted with cyano compounds in the presence of sulfamic acid or its salts with the addition of solvents. The reaction is represented in Reaction Scheme 1.

In the known processes, large amounts of ammonia are generated. This happens both in the reaction of the polyfunctional amines with ammonium salts or with sulfamic acid and in the subsequent polycondensation with the cyano compounds. In the first reaction step of the reaction of the polyfunctional amines with ammonium salts or with sulfamic acid, one mole of ammonia is generated per mole of ammonium salts or per mole of sulfamic acid. In the second reaction step, the polycondensation with the cyano compound, another mole of ammonia is generated per mole of amine component of the first reaction step and per mole of the cyano compound. This ammonia must be captured by the exhaust air purification facility.

U.S. Pat. No. 6,008,316 A describes a process for reacting polyamines, which are obtainable by the polycondensation of monomeric amines, with cyano or guanidino compounds. The reaction is represented in Reaction Scheme 2.

The object of the present invention is, in particular, to improve the processes of the prior art, and to provide known products.

The core of the present invention is a process for the preparation of such basic polycondensation products as known from the EP patents mentioned while reducing the amount of released ammonia. Surprisingly, it has now been found that this can be achieved by partially or completely neutralizing the polyfunctional amines with aqueous solutions of inorganic or organic acids, followed by distilling off the water and anhydrous reaction by polycondensation with cyano compounds. The reaction is also represented in Reaction Scheme 1.

Therefore, in a first embodiment, the present invention relates to a process for preparing basic polycondensation products, characterized by the following steps:
a) neutralizing a polyfunctional amine selected from 1,4-butanediamine, 1,6-hexanediamine, N-(2-aminoethyl)-1,3-propanediamine, dipropylene triamine, N,N-bis(2-aminopropyl)methylamine, diethylene triamine, triethylene tetramine and/or tetraethylene pentamine at first partially or completely with the aqueous solution of an inorganic or organic acid in a first process step;
b) distilling off water in a second process step; and
c) reacting the product obtained according to process step b) in a polycondensation reaction with a cyano compound with the release of ammonia at temperatures of at least 100° C.

This process can be performed in a controlled way and with a very high process safety. The reduction of the amount of ammonia released as compared with a completely anhydrous process is the most important criterion for the technical performance of the process.

The preparation of these polycondensation products can be effected in solvents, and it is also possible to accelerate the reaction by adding a catalyst.

Basic polycondensation products according to the invention can be neutralized with aqueous acid and then used for improving the fastness of textile dyes or as a precationizing agent in the dyeing of textiles.

The aqueous solutions of acids employed are solutions of inorganic or organic acids. Preferred inorganic acids include, for example, hydrochloric acid or sulfuric acid, and preferred organic acids include, for example, formic acid or acetic acid.

The distillation conditions for removing the water are to be matched to the reaction mixture. Preferably, the distillation is performed at temperatures of no greater than 180° C. It may be effected under vacuum or under normal pressure, or it may start at first under normal pressure and then be continued under vacuum to complete the distillation.

Suitable cyano compounds for the process include, for example, cyanamide, dicyandiamide, guanidine or biguanidine. The condensation reactions between the polyfunctional amine derivatives and the cyano compounds are preferably effected in a temperature range of from 100° C. to 250° C., preferably in a range of from 120° C. to 230° C.

The process can be performed with or without a solvent or with the aid of solvents. Preferred solvents include, for example, polyhydric alcohols, such as ethylene glycol, di-, tri- or tetraethylene glycol, propylene glycol, butylene glycol and polyethylene glycol. Mixtures of different solvents may also be used. Solvents, when used, may be added either at the beginning of the process or before the polycondensation with the cyano compound. The use of solvents provides for a reduction of viscosity during the polycondensation.

To accelerate the process, a catalyst may optionally be added. Suitable catalysts include metal halides, such as zinc chloride. However, the addition of a catalyst is not necessarily required for performing the process.

The basic polycondensation products prepared according to the invention can be employed, for example, as textile treating agents, especially as aftertreatment agents for improving the fastness of dyes, or a precationizing agents in dyeing.

### EXAMPLES

The following Examples in which “parts” means parts by weight illustrate the invention.

### Example 1

In a reaction vessel, 64.2 parts of ethylene glycol and 235.5 parts of hydrochloric acid (31%) were charged at first, and 103.2 parts of diethylene triamine was metered to the mixture at a maximum of 35° C. Subsequently, a vacuum was applied at 30° C., and the temperature was increased to 100° C. and maintained for 30 minutes. In this time, 162.5 parts of water was distilled off. After the addition of another 57.3 parts of ethylene glycol, 105.1 parts of dicyandiamide was added at 70° C., and within 90 minutes, the mixture was heated at 160° C., stirred at 160° C. for 30 minutes, and cooled down to 100° C. within 45 minutes to release 38.3 parts of ammonia. Then, 270.0 parts of water was slowly added, which caused the temperature to drop below 100° C. Cooling was continued, and 25.4 parts of acetic acid (60%) and 150.1 parts of water were successively added. In this way, 810.0 parts of a yellow to reddish solution was obtained. The amount of ammonia released is stated in the Table.

### Comparative Example 1

In a reaction vessel, 121.5 parts of ethylene glycol and 103.2 parts of diethylene triamine were charged at first, and 107.0 parts of ammonium chloride was metered to the mixture. Subsequently, the temperature was increased to 160° C. and maintained for 30 minutes. In this time, 34.0 parts of ammonia was released. Subsequently, the mixture was cooled down to 70° C., 105.1 parts of dicyandiamide was added, and the mixture was heated at 160° C. within 90 minutes, stirred at 160° C. for 30 minutes, and cooled down to 100° C. within 45 minutes to release 38.3 parts of ammonia. Then, 270.0 parts of water was slowly added, which caused the temperature to drop below 100° C. Cooling was continued, and 25.4 parts of acetic acid (60%) and 150.1 parts of water were successively added. In this way, 810.0 parts of a yellow to reddish solution was obtained. The amount of ammonia released is stated in the Table.

### Example 2

In a reaction vessel, 64.2 parts of ethylene glycol and 235.5 parts of hydrochloric acid (31%) were charged at first, and 103.2 parts of diethylene triamine was metered to the mixture at a maximum of 35° C. Subsequently, a vacuum was applied at 30° C., and the temperature was increased to 100° C. and maintained for 30 minutes. In this time, 162.5 parts of water was distilled off. After the addition of another 32.1 parts of ethylene glycol, 42.0 parts of dicyandiamide was added at 70° C., and within 90 minutes, the mixture was heated at 160° C., stirred at 160° C. for 30 minutes, and cooled down to 100° C. within 45 minutes to release 25.5 parts of ammonia. Then, 214.1 parts of water was slowly added, which caused the temperature to drop below 100° C. Cooling was continued, and 47.1 parts of acetic acid (60%) and 92.1 parts of water were successively added. In this way, 642.3 parts of a yellow to red solution was obtained. The amount of ammonia released is stated in the Table.

### Comparative Example 2

In a reaction vessel, 96.3 parts of ethylene glycol and 103.2 parts of diethylene triamine were charged at first, and 107.0 parts of ammonium chloride was metered to the mixture. Subsequently, the temperature was increased to 160° C. and maintained for 30 minutes. In this time, 34.0 parts of ammonia was released. Subsequently, the mixture was cooled down to 70° C., 42.0 parts of dicyandiamide was added, and the mixture was heated at 160° C. within 90 minutes, stirred at 160° C. for 30 minutes, and cooled down to 100° C. within 45 minutes to release 25.5 parts of ammonia. Then, 214.1 parts of water was slowly added, which caused the temperature to drop below 100° C. Cooling was continued, and 47.1 parts of acetic acid (60%) and 92.1 parts of water were successively added. In this way, 642.3 parts of a yellow to reddish solution was obtained. The amount of ammonia released is stated in the Table.

The following Table shows the advantage of Examples 1 and 2 according to the invention over Comparative Examples 1 and 2.

| Example | Ammonia released |
|---|---|
| Example 1 | 38.3 parts |
| Comparative Example 1 | 72.3 parts |
| Example 2 | 25.5 parts |
| Comparative Example 2 | 59.5 parts |

It is seen that only a substantially lower amount of ammonia is released in both cases according to the invention. In Example 1, it is only 53.0%, based on Comparative Example 1, and in Example 2, this is only 42.9%, based on Comparative Example 2.

1. A process for preparing basic polycondensation products, characterized by the following steps:
a) neutralizing a polyfunctional amine selected from 1,4-butanediamine, 1,6-hexanediamine, N-(2-aminoethyl)-1,3-propanediamine, dipropylene triamine, N,N-bis(2-aminopropyl)methylamine, diethylene triamine, triethylene tetramine and/or tetraethylene pentamine with the aqueous solution of an inorganic or organic acid;
b) distilling off water; and
c) reacting the product obtained according to process step b) in a polycondensation reaction with a cyano compound with the release of ammonia at temperatures of at least 100° C.

2. The process according to claim 1, characterized in that said inorganic or organic acid is selected from the group consisting of hydrochloric acid, sulfuric acid, formic acid and/or acetic acid.

3. The process according to claim 1 characterized in that said cyano compound is selected from the group consisting of cyanamide, dicyandiamide, guanidine and/or biguanidine.

4. The process according to claim 1, characterized in that a solvent is employed for one or more of process steps a), b), and c).

5. The process according to claim 4 characterized in that said solvent contains hydroxyl groups.

6. The process according to claim 1, characterized in that a catalyst is employed for process step c).

7. The process according to claim 6, characterized in that a metal halide is employed as said catalyst.

8. The process according to claim 1, characterized in that the water is distilled off in process step b) at a temperature of up to 180° C.

9. The process according to claim 1, characterized in that the polycondensation reaction according to process step c) is performed at a temperature within a range of from 100° C. to 250° C.

10. The process according to claim 1, characterized in that the polycondensation product obtained according to process step c) is at least partially neutralized with an inorganic or organic acid.

11. The process according to claim 5, characterized in that said hydroxy groups are in the form of polyhydric alcohols selected from the group consisting of ethylene glycol, diethylene, triethylene or tetraethylene glycol, propylene glycol, butylenes glycol or polyethylene glycol as well as a mixture of these solvents.

12. The process according to claim 7, characterized in that said metal halide is zinc chloride.

13. The process according to claim 8, wherein the water distillation step is at least partially carried out under vacuum.

14. The process according to claim 10, wherein said inorganic or organic acid is selected from the group consisting of hydrochloric acid, sulfuric acid, formic acid and acetic acid.
